(19) United States
(12) Patent Application Publication
(10) Pub. No.: US 2025/0283416 A1
(43) Pub. Date: Sep. 11, 2025

(54) TURBINE VANE WITH LEADING EDGE COOLING

(71) Applicant: RTX Corporation, Farmington, CT (US)

(72) Inventors: Jaime G. Ghigliotty Rosado, Cabo Rojo, PR (US); Dominic J. Mongillo, JR., West Hartford, CT (US); Efrain Vega Rios, Manati, PR (US); Russell J. Bergman, South Windsor, CT (US); Omar D. Zambrana Toth, Aguadilla, PR (US); Pedro Peralta Trinidad, Caguas, PR (US); Fernando Monserrate, Isabela, PR (US)

(21) Appl. No.: 18/596,309

(22) Filed: Mar. 5, 2024

(51) Int. Cl. F01D 5/18; F01D 25/12

(52) U.S. Cl. CPC F01D 5/187; F01D 25/12; F05D 2260/20

(57) ABSTRACT

A vane for a gas turbine engine, including: an airfoil extending between an inner platform and an outer platform, the outer platform of the vane having a leading edge and a trailing edge; a passage located in the vane for providing cooling airflow to the leading edge; and an internal plenum located in the outer platform, the internal plenum being in fluid communication with the passage via a plurality of passages each of the plurality of passages fanning outwardly from the passage and each of the plurality of passages being separated by one of a plurality of ribs located in the outer platform.

### GOVERNMENT RIGHTS STATEMENT

This invention was made with Government support under Contract N00019-21-G-0005, D.O. N00019-23 F-0019 awarded by the United States Navy. The Government has certain rights in this invention.

### BACKGROUND

This disclosure relates to a gas turbine engine, and more particularly to a turbine vane with cooling features.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

As mentioned above, hot combustion gases are communicated through the turbine section, which causes the turbine vanes to be exposed to high temperatures. As such, it is desirable to provide cooling to the turbine vanes.

### BRIEF DESCRIPTION

Disclosed is a vane for a gas turbine engine, including: an airfoil extending between an inner platform and an outer platform, the outer platform of the vane having a leading edge and a trailing edge; a passage located in the vane for providing cooling airflow to the leading edge; and an internal plenum located in the outer platform, the internal plenum being in fluid communication with the passage via a plurality of passages each of the plurality of passages fanning outwardly from the passage and each of the plurality of passages being separated by one of a plurality of ribs located in the outer platform.

In addition to one or more of the features described above, or as an alternative to any of the foregoing embodiments, the internal plenum has a larger volume than each one of the plurality of passages.

In addition to one or more of the features described above, or as an alternative to any of the foregoing embodiments, cooling openings extending from the internal plenum to an external surface of the leading edge.

In addition to one or more of the features described above, or as an alternative to any of the foregoing embodiments, cooling openings extending from the internal plenum to any one of an external surface of the leading edge, matefaces of the outer platform, and a radially inwardly facing surface of the outer platform.

In addition to one or more of the features described above, or as an alternative to any of the foregoing embodiments, the internal plenum is located between the plurality of passages and an external surface of the outer platform.

In addition to one or more of the features described above, or as an alternative to any of the foregoing embodiments, an area of each of the passages is equal.

In addition to one or more of the features described above, or as an alternative to any of the foregoing embodiments, each of the plurality of passages are connected to the internal plenum.

In addition to one or more of the features described above, or as an alternative to any of the foregoing embodiments, the vane is a turbine vane.

In addition to one or more of the features described above, or as an alternative to any of the foregoing embodiments, the vane is formed from a casting process.

In addition to one or more of the features described above, or as an alternative to any of the foregoing embodiments, upper surfaces and/or lower surfaces of the plurality of passages have trip strips extending therefrom.

Also disclosed is a gas turbine engine, including: a fan section; a compressor section; a combustor section; and a turbine section, the turbine section including at least one vane, the at least one vane including: an airfoil extending between an inner platform and an outer platform, the outer platform of the at least one vane having a leading edge and a trailing edge; a passage located in the at least one vane for providing cooling airflow to the leading edge; and an internal plenum located in the outer platform, the internal plenum being in fluid communication with the passage via a plurality of passages each of the plurality of passages fanning outwardly from the passage and each of the plurality of passages being separated by one of a plurality of ribs located in the outer platform.

In addition to one or more of the features described above, or as an alternative to any of the foregoing embodiments, the internal plenum has a larger volume than each one of the plurality of passages.

In addition to one or more of the features described above, or as an alternative to any of the foregoing embodiments, cooling openings extending from the internal plenum to an external surface of the leading edge.

In addition to one or more of the features described above, or as an alternative to any of the foregoing embodiments, cooling openings extending from the internal plenum to any one of an external surface of the leading edge, matefaces of the outer platform, and a radially inwardly facing surface of the outer platform.

In addition to one or more of the features described above, or as an alternative to any of the foregoing embodiments, the internal plenum is located between the plurality of passages and an external surface of the outer platform.

In addition to one or more of the features described above, or as an alternative to any of the foregoing embodiments, an area of each of the passages is equal.

In addition to one or more of the features described above, or as an alternative to any of the foregoing embodiments, each of the plurality of passages are connected to the internal plenum.

In addition to one or more of the features described above, or as an alternative to any of the foregoing embodiments, the at least one vane is formed from a casting process.

In addition to one or more of the features described above, or as an alternative to any of the foregoing embodiments, upper surfaces and/or lower surfaces of the plurality of passages have trip strips extending therefrom.

Also disclosed is a core for forming a vane for a gas turbine engine, the vane including: an airfoil extending between an inner platform and an outer platform, the outer platform of the vane having a leading edge and a trailing edge; a passage located in the vane for providing cooling airflow to the leading edge; and an internal plenum located in the outer platform, the internal plenum being in fluid communication with the passage via a plurality of passages each of the plurality of passages fanning outwardly from the passage and each of the plurality of passages being separated by one of a plurality of ribs located in the outer platform, the core including: a forward region that corresponds to the internal plenum; a plurality of fingers that correspond to the plurality of passages, the plurality of fingers extending from the forward region; and a plurality of openings located between the plurality of fingers, the plurality of openings corresponding to the plurality of ribs.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine in accordance with this disclosure;

FIG. 2 is a schematic view of a portion of a turbine section of the gas turbine engine;

FIG. 3 is a view of a turbine vane in accordance with the present disclosure;

FIG. 4 is a perspective view of an upper portion of the vane illustrated in FIG. 3 with a ceramic core;

FIG. 5 is a view along lines 5-5 in FIG. 3;

FIG. 6 is an opposite view of a portion of the vane illustrated in FIG. 5;

FIG. 7 is a perspective view of a core for forming a portion of the vane of the present disclosure;

FIG. 8 a perspective view of a portion of a vane of the present disclosure;

FIG. 9 is a view along lines 9-9 in FIG. 8;

FIG. 10 a perspective view of a portion of a vane of the present disclosure;

FIG. 11 is a view along lines 11-11 in FIG. 10; and

FIG. 12 is a view along lines 12-12 in FIG. 10.

### DETAILED DESCRIPTION

A detailed description of one or more embodiments of the disclosed turbine vane and method of cooling are presented herein by way of exemplification and not limitation with reference to the FIGS.

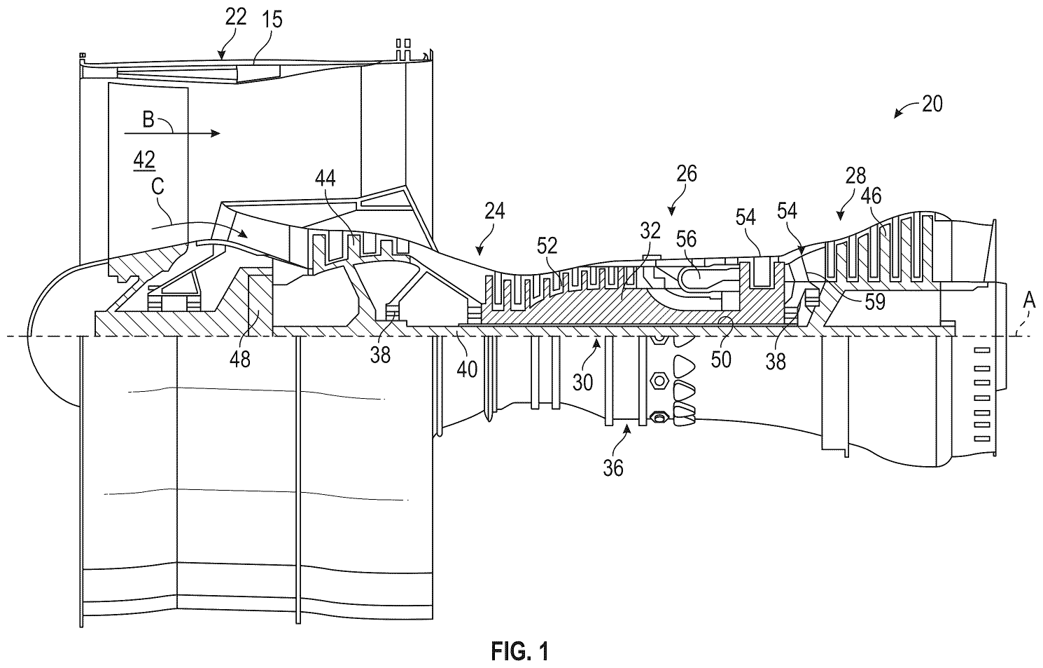

FIG. 1 schematically illustrates a gas turbine engine 20. The gas turbine engine 20 disclosed herein is provided as one non-limiting example of an engine the vane of the present disclosure may be used in. In other words, the turbine vane and method of cooling may be used in any suitable gas turbine engine and its use is not limited to the specific engine architectures illustrated in the attached FIGS. The gas turbine engine 20 illustrated in FIG. 1 may be referred to as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first or low pressure compressor 44 and a first or low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. It being understood that various embodiments of the present disclosure are applicable to engines that may or may not have the aforementioned geared architecture 48. The high speed spool 32 includes an outer shaft 50 that interconnects a second or high pressure compressor 52 and a second or high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions and configurations of the fan section 22, compressor section 24, combustor section 26, turbine section 28, and fan drive gear system 48 may be varied. For example, gear system 48 may be located aft of combustor section 26 or even aft of turbine section 28 or removed entirely, and fan section 22 may have different configurations and/or may be positioned forward or aft of the location of gear system 48.

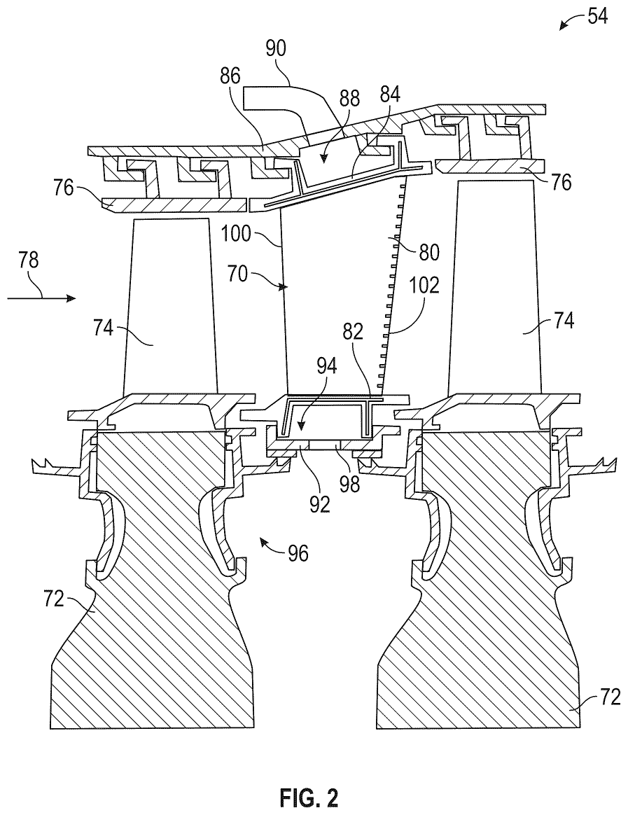

FIG. 2 illustrates a portion of the high pressure turbine (HPT) 54. FIG. 2 also illustrates at least one high pressure turbine stage vane 70 that is located aft of a first one of a pair of turbine disks 72 and forward of the other one of the pair of turbine disks 72. Each of the pair of turbine disks 72 having a plurality of turbine blades 74 secured thereto. The turbine blades 74 rotate proximate to blade outer air seals (BOAS) 76 which are located radially outward of tips of the turbine blades 74.

The high pressure turbine stage vanes 70 are positioned circumferentially about the axis A of the engine. Hot gases from the combustor section 26 flow through the turbine in the direction of arrow 78. Although a two-stage high pressure turbine is illustrated other high pressure turbines are considered to be within the scope of various embodiments of the present disclosure. Each of the vanes 70 have an airfoil 80 extending between an inner platform 82 and an outer platform 84. The blade outer air seals (BOAS) 76 and the outer platform 84 are secured to a case 86 that circumferentially surrounds the high pressure turbine 54.

The high pressure turbine (HPT) 54 is subjected to gas temperatures well above the yield capability of its material. In order to mitigate such high temperature detrimental effects, surface film-cooling is typically used to cool the blades and vanes of the high pressure turbine. Surface film-cooling is achieved by supplying cooling air from the cold backside through cooling holes drilled on the high pressure turbine components. Cooling holes are strategically designed and placed on the vane and turbine components in-order to maximize the cooling effectiveness and minimize the efficiency penalty.

In addition, internal cooling passageways and interconnecting cooling openings or crossovers are provided to allow for cooling air flow within the blades and vanes of the high pressure turbine. The outer platform 84 and the case 86 defines a cavity 88 which receives cooling air from a cooling air pipe 90 that is in fluid communication with the cavity 88. Although only one cooling air pipe 90 is illustrated, a plurality of cooling air pipes may be positioned about a circumference of the case 86.

Secured to the inner platform 82 is an inner air seal or full hoop inner seal 92, which in conjunction with the inner platform 82 forms a vane inner diameter cavity 94. The vane inner diameter cavity 94 is in fluid communication with a rotor cavity 96 via at least one opening 98 in the inner air seal or full hoop inner seal 92.

In accordance with the present disclosure the outer platform 84 of the vane 70 is provided with a cooling scheme that provides uniform cooling to a surface of the outer platform 84. In addition, the cooling design of the outer platform 84 employs a design that also improves the stiffness of a core used for forming the vane 70 of the present disclosure.

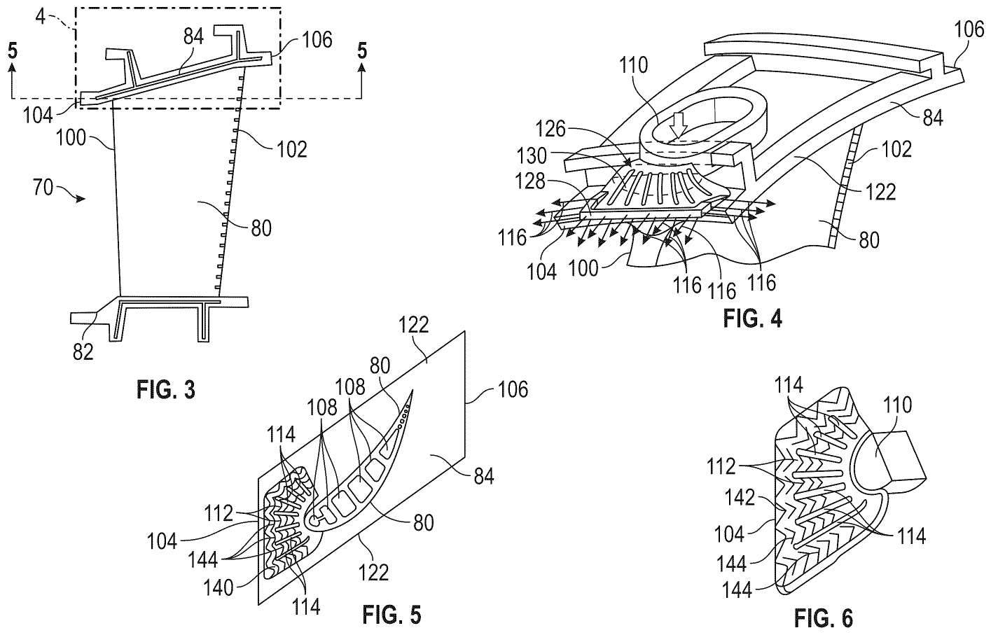

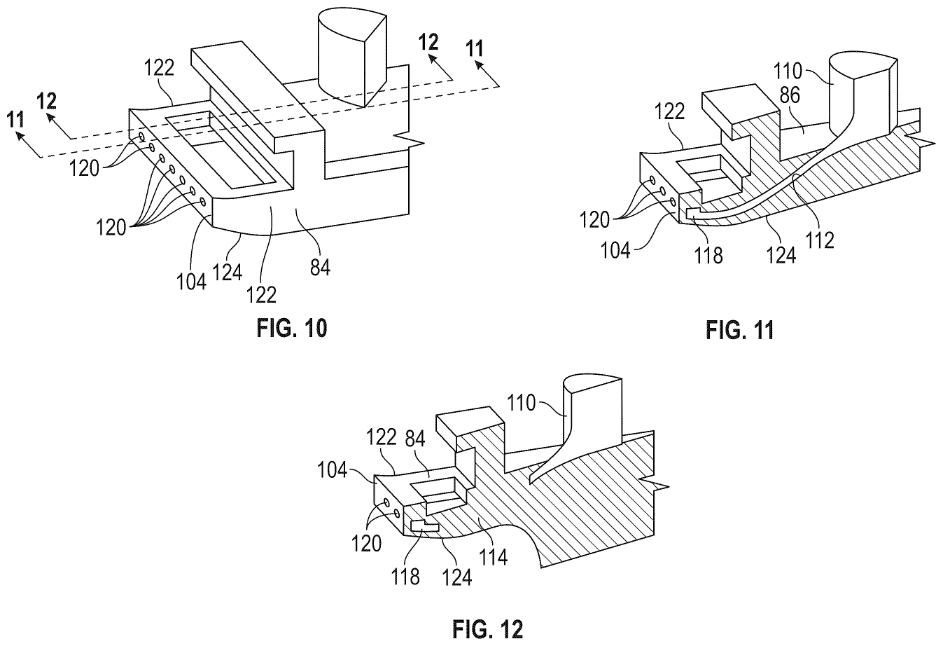

Referring now to at least FIGS. 1-12, a vane 70 in accordance with the present disclosure is illustrated. As mentioned above, each of the vanes 70 have an airfoil 80 extending between an inner platform 82 and an outer platform 84. The airfoil 80 of the vane 70 has a leading edge 100 and a trailing edge 102. The leading edge 100 encountering the hot gases from the combustor section before the trailing edge 102. Similarly, the outer platform 84 of the vane 70 has a leading edge 104 and a trailing edge 106. The leading edge 104 encountering the hot gases from the combustor section before the trailing edge 106.

The inner platform 82 and the outer platform 84 are mounted into the engine structure at both radially inner and radially outer end of the airfoil 80. As known, the airfoil 80 serves to redirect the products of combustion between turbine rotor stages.

As shown in FIG. 5, the airfoil 80 has cooling passages 108 extending therethrough. The cooling passages 108 are in fluid communication with a passage 110 in outer platform 84. See at least FIG. 4. The passage 110 supplies cooling flow to passages 112 that provide cooling air forwardly toward the leading edge 104 of the outer platform 84. As illustrated, multiple passages 112 are separated by fanned ribs 114 to improve passage flow fill and to maintain uniform flow per area. Flow exiting the cooling passages 112 is illustrated by arrows 116 in at least FIG. 4. In accordance with the present disclosure, all of the passages 112 connect into a manifold, internal plenum or bump-out region 118. The manifold, internal plenum or bump-out region 118 has a larger volume than passages 112. As illustrated in at least FIG. 4, the manifold, internal plenum or bump-out region 118 is located between the plurality of passages 112 and an external surface of the outer platform 84.

In order to provide the cooling airflow in the direction of arrows 116, cooling openings 120 are drilled into the vane 70 after it have been formed. The cooling openings 120 are drilled until they are in fluid communication with the manifold, internal plenum or bump-out region 118.

Once the vane is fully formed the cooling openings 120 are formed or drilled into anyone of or all of an exterior surface of the leading edge 104, matefaces 122 and a radially inwardly facing surface 124 of the outer platform 84. In one embodiment, the manifold, internal plenum or bump-out region 118 may have a “U” shaped configuration such that it is located between the exterior surface of the leading edge 104 and the exterior surface of the matefaces 122 of the outer platform 84 and the passages 112.

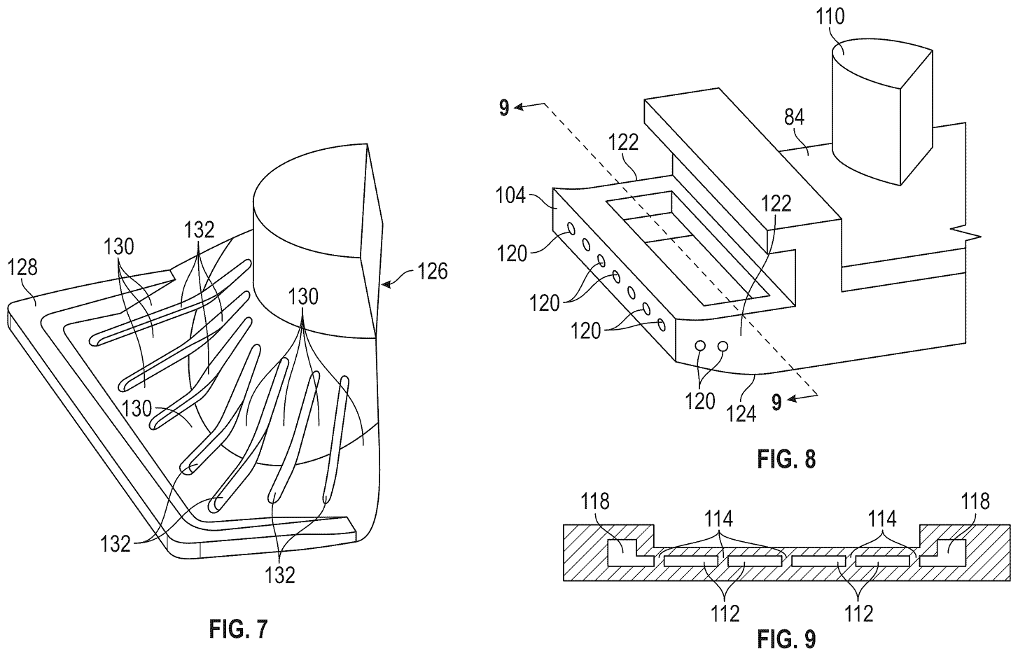

Referring now to FIG. 7, a perspective view of a core 126 for forming the forward section of outer platform 84. As illustrated in at least FIG. 4 the core 126 is applied to a partially formed vane 70 so that the aforementioned passages 112, ribs 114 and internal plenum or bump-out region 118 can be formed with the vane 70. In other words, the vane 70 comprising at least the airfoil 80, the inner platform 82 and at least a portion of the outer platform 84 is first formed. Thereafter and after these portions are formed the core 126 is applied to the partially formed vane 70. The core 126 has a forward region 128 that corresponds to the manifold, internal plenum or bump-out region 118 and a plurality of fingers 130 that correspond to passages 112 and a plurality of openings 132 that correspond to the ribs 114.

As is known in the related arts, the vane 70 is cast or is formed from a casting process, and typically utilizes a lost core molding technique. For example, a first portion of the vane without the passages 112, ribs 114 and internal plenum or bump-out region 118 is formed by the lost core molding technique. Thereafter, the partially formed vane has the core 126 applied thereto and the passages 112, ribs 114 and internal plenum or bump-out region 118 is formed by the lost core molding technique to provide a fully formed vane 70 in accordance with the present disclosure. As mentioned above, the core 126 will include spaces or openings 132 for the ribs 114, and is solid at the location of the passages 112 and the manifold or bump out region 118 as well as passage 110. After metal is cast around the core 126, the core 126 is leached away, leaving the vane 70 as shown in the figures. Thus, the ribs 114 cast. The plurality of fingers 130 that correspond to passages 112 improve the core stiffness and provide a more producible design.

The openings 132 that correspond to the ribs 114 terminate short from the enlarged zone or manifold or bump out region 118 where cooling holes 120 are drilled to provide fluid flow for the cooling air.

The configuration of the fingers 130 on the platform core 126 allow the corresponding passages 112 to distribute cooling flow uniformly and towards the leading edge 104 of the outer platform 84. The ribs 114 are placed to improve internal flow fill characteristics (i.e., mitigate regions of internal flow separation and recirculation). In an alternative configuration, the ribs 114 could be positioned such that the flow over area is equality distributed along the passages 112, which allows for more uniform metal temperature distribution on the platform 84. In other words, the area of the passages 112 is equal. All the cavities 112 connect into the manifold, internal plenum or bump-out region 118. The manifold, internal plenum or bump-out region 118 is corresponds to the forward region 128 of the core 126 that is enlarged and improves the core 126 stiffness. This makes the core 126 less prone to breaking while keeping the design manufacturable through conventional casting process. Cooling holes 120 are also drilled into this enlarged plenum or bump out region 118 to get the flow out. The bump-out zone allows to holes 120 to be drilled from the surfaces of the outer platform 84 (e.g., leading edge 104, radially inwardly facing surface 124, and mateface sides 122). As shown in FIG. 7, the openings 132 correspond to the ribs 114 that terminate short of the bump-out region or plenum 118 formed by area 128 of the core 126. Terminating of the ribs short of the bump-out region or plenum 118 facilitates a film hole 120 layout optimization regarding hole, row spacing and orientation. The cooling holes 120 could also be drilled into the individual passages to get cooling flow out where needed. As such, the cooling air flow is metered by drilled cooling holes 120 instead of a cast feature.

As mentioned above, turbine airfoils can be operating in a gas-path temperature far exceeding their melting point. To endure these temperatures, they must be cooled to an acceptable service temperature in order to maintain their integrity. In accordance with the present disclosure, the core 126 is designed to accommodate complex internal cooling passages to channel and direct the cooling air in a fan shaped configuration as illustrated in at least FIG. 4.

The fanned ribs 114 of the platform core 84 allow the passages 112 to distribute cooling flow uniformly and towards the leading edge 104. The ribs 114 are placed to improve internal flow fill characteristics (i.e., mitigate regions of internal flow separation and recirculation). In another configuration, the ribs 114 could be positioned such that flow over area is equality distributed along the passages 112, which allows for more uniform metal temperature distribution on the platform 84. All cavities 112 connect into a manifold (bump-out region) 118 which also improves the core 126 stiffness. This makes the core 126 less prone to breaking while keeping the design manufacturable through conventional casting process.

FIGS. 5 and 6 are views illustrating ribs 114 and an upper surfaces 140 or lower surfaces 142 of passages 112. As illustrated, the upper surfaces 140 and/or the lower surfaces 142 may be provided with trip strips 144 in order to enhance the convective cooling through passages 112. As used herein, trip strips are protrusions that extend away from a surface such that the disrupt airflow passing past the trip strips in order to create eddies or swirling flow patterns of the cooling airflow in order to enhance the cooling provided by the cooling airflow. For example, the eddies or swirling flow patterns improves the cooling of portions of the vane 70 proximate to the eddies or swirling flow patterns of the cooling airflow.

While the vane 70 is shown as having a single airfoil 80 extending between the opposed platforms 82, 84, the present disclosure would also extend to vanes having a plurality of airfoils 80 connected to each platform 82, 84.

Although, FIG. 2 shows that the vane 70 may be used in the turbine section 28 in either or both of the high pressure and low pressure sections, the vane 70 may be used in other locations of the engine 20 in addition to or as an alternative to the turbine section 28. Non limiting locations include, the compressor section (high and low) as well as another other section of the engine 20 that has a vane 70 or component needing a cooling air flow.

As used herein forward and aft are with reference to the core and bypass flow path from the fan section 22 (e.g., forward) towards the turbine section 28 (e.g., aft). In addition, the term radially is with reference to the engine central longitudinal axis A. For example, radially inward refers to a direction towards the engine central longitudinal axis A and radially outward refers to a direction away from the engine central longitudinal axis A. As such, radially inward platforms 82 are closer to the engine central longitudinal axis A than the radially outward platforms 84, when the vane 70 is installed in the gas turbine engine 20.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A vane for a gas turbine engine, comprising:
an airfoil extending between an inner platform and an outer platform, the outer platform of the vane having a leading edge and a trailing edge;
a passage located in the vane for providing cooling airflow to the leading edge; and
an internal plenum located in the outer platform, the internal plenum being in fluid communication with the passage via a plurality of internal passages each of the plurality of internal passages extending from the passage and fanning outwardly from the passage and each of the plurality of internal passages being separated by one of a plurality of ribs located in the outer platform.

2. The vane as in claim 1, wherein the internal plenum has a larger volume than each one of the plurality of passages.

3. The vane as in claim 1, further comprising: cooling openings extending from the internal plenum to an external surface of the leading edge.

4. The vane as in claim 1, further comprising: cooling openings extending from the internal plenum to any one of an external surface of the leading edge, matefaces of the outer platform, and a radially inwardly facing surface of the outer platform.

5. The vane as in claim 1, wherein the internal plenum is located between the plurality of passages and an external surface of the outer platform.

6. The vane as in claim 1, wherein an area of each of the plurality of internal passages is equal.

7. (canceled)

8. The vane as in claim 1, wherein the vane is a turbine vane.

9. The vane as in claim 1, wherein the vane is formed from a casting process.

10. The vane as in claim 1, wherein upper surfaces and/or lower surfaces of the plurality of internal passages have trip strips extending therefrom.

11. A gas turbine engine, comprising:
a fan section;
a compressor section;
a combustor section; and
a turbine section, the turbine section including at least one vane, the at least one vane comprising:
an airfoil extending between an inner platform and an outer platform, the outer platform of the at least one vane having a leading edge and a trailing edge;
a passage located in the at least one vane for providing cooling airflow to the leading edge; and
an internal plenum located in the outer platform, the internal plenum being in fluid communication with the passage via a plurality of internal passages each of the plurality of internal passages extending from the passage and fanning outwardly from the passage and each of the plurality of internal passages being separated by one of a plurality of ribs located in the outer platform.

12. The gas turbine engine as in claim 11, wherein the internal plenum has a larger volume than each one of the plurality of internal passages.

13. The gas turbine engine as in claim 11, further comprising: cooling openings extending from the internal plenum to an external surface of the leading edge.

14. The gas turbine engine as in claim 11, further comprising: cooling openings extending from the internal plenum to any one of an external surface of the leading edge, matefaces of the outer platform, and a radially inwardly facing surface of the outer platform.

15. The gas turbine engine as in claim 11, wherein the internal plenum is located between the plurality of internal passages and an external surface of the outer platform.

16. The gas turbine engine as in claim 11, wherein an area of each of the plurality of internal passages is equal.

17. (canceled)

18. The gas turbine engine as in claim 11, wherein the at least one vane is formed from a casting process.

19. The gas turbine engine as in claim 11, wherein upper surfaces and/or lower surfaces of the plurality of internal passages have trip strips extending therefrom.

20. A core for forming a vane for a gas turbine engine, the vane including: an airfoil extending between an inner platform and an outer platform, the outer platform of the vane having a leading edge and a trailing edge; a passage located in the vane for providing cooling airflow to the leading edge; and an internal plenum located in the outer platform, the internal plenum being in fluid communication with the passage via a plurality of internal passages each of the plurality of internal passages extending from the passage and fanning outwardly from the passage and each of the plurality of internal passages being separated by one of a plurality of ribs located in the outer platform, the core comprising:
a forward region that corresponds to the internal plenum;
a plurality of fingers that correspond to the plurality of internal passages, the plurality of fingers extending from the forward region; and
a plurality of openings located between the plurality of fingers, the plurality of openings corresponding to the plurality of ribs.
